(19) United States
(12) Patent Application Publication
(10) Pub. No.: US 2013/0240479 A1
(43) Pub. Date: Sep. 19, 2013

(54) METHOD FOR PRODUCING FILTRATION FILTER

(71) Applicant: Tokyo Electron Limited, Tokyo (JP)

(72) Inventors: Tsuyoshi MORIYA, Tokyo (JP); Kenichi Kataoka, Nirasaki-shi (JP); Shigeru Senzaki, Kurokawa-gun (JP); Youichi Shimanuki, Nirasaki-shi (JP); Kazuhiko Kano, Fuchu-shi (JP); Yu Wamura, Nirasaki-shi (JP); Song yun Kang, Nirasaki-shi (JP); Eiichi Nishimura, Nirasaki-shi (JP)

(21) Appl. No.: 13/890,529

(22) Filed: May 9, 2013

Related U.S. Application Data
(63) Continuation of application No. PCT/JP2011/076129, filed on Nov. 8, 2011.

(30) Foreign Application Priority Data
Nov. 11, 2010 (JP) 2010-253080

(51) Int. Cl. B01D 67/00

(52) U.S. Cl. CPC B01D 67/0023
USPC 216/39; 156/60; 156/292; 156/293

(57) ABSTRACT

To provide a method for producing a filtration filter that can simplify the process for providing clean water or freshwater. By etching silicon substrate 1 using masking film formed on a surface of substrate 1 and having numerous openings to expose portions of the surface, numerous circular holes 2 with an approximate diameter of 100 nm are formed in substrate 1. Diameter (D1) at minimum-diameter portions 4 near the openings of circular holes 2 to be reduced by silica film 3 is adjusted to be 1 nm˜100 nm by depositing silica film 3 on the inner surfaces of circular holes 2.

### CROSS-REFERENCE TO RELATED APPLICATIONS

The present application is a continuation of PCT International Application No. PCT/JP2011/076129, filed Nov. 8, 2011, which is based upon and claims the benefit of priority from Japanese Application No. 2010-253080, filed Nov. 11, 2010. The entire contents of these applications are incorporated herein by reference.

### BACKGROUND OF THE INVENTION

1. Field of the Invention

The present invention relates to a method for producing a filtration filter.

2. Description of Background Art

Filtration filters are often used to produce clean water from factory and household wastewater (sewage) by removing contaminants and foreign matter or to produce freshwater from seawater by removing salt content or the like. As for filtration filters, reverse osmosis membranes made of polymeric material such as polymeric membranes of methyl acetate are known. A reverse osmosis membrane has numerous penetrating holes with a diameter of a few nanometers. When pressure is added to sewage or seawater to make it flow through such penetrating holes, contaminant molecules the size of a few dozen nanometers and hydrated sodium ions surrounded by water molecules cannot pass through the penetrating holes, while water molecules each with an approximate diameter of 0.38 nm can pass though the penetrating holes. Accordingly, the reverse osmosis membrane produces clean water or freshwater from sewage or seawater by separating water molecules from contaminants or salt content.

However, when polluted water is purified using reverse osmosis membranes to provide clean water in developing countries and areas stricken by natural disasters, problems arise such as a notably reduced life span for reverse osmosis membranes due to bacteria contained in polluted water that cause decay in polymeric membranes.

Also, since salt and fine sand tend to be mixed into lubricating oil in windmill-type wind power generators located along shore lines, it is strongly required that salt and fine sand be removed from lubricating oil. However, if reverse osmosis membranes are used to remove salt and fine sand, ingredients of the lubricating oil may dissolve polymeric membranes, causing problems such as a notably short life span for the reverse osmosis membranes.

### SUMMARY OF THE INVENTION

According to one aspect of the present invention, a method for producing a filtration filter includes using masking film formed on a surface of a rigid substrate and having a plurality of openings with a uniform size to expose portions of the surface, etching the portions of the substrate corresponding to the openings, and forming a plurality of holes or grooves in the substrate.

According to one aspect of the present invention, a method for producing a filtration filter includes laminating a plurality of rigid substrates by means of organic material to have a predetermined distance from each other, and removing the organic material.

### BRIEF DESCRIPTION OF THE DRAWINGS

A more complete appreciation of the invention and many of the attendant advantages thereof will be readily obtained as the same becomes better understood by reference to the following detailed description when considered in connection with the accompanying drawings, wherein:

FIG. 1A is a view showing a step of a method for producing a filtration filter according to a first embodiment of the present invention;

FIG. 1B is a view showing a step of a method for producing a filtration filter according to the first embodiment of the present invention;

FIG. 1C is a view showing a step of a method for producing a filtration filter according to the first embodiment of the present invention;

FIG. 1D is a view showing a step of a method for producing a filtration filter according to the first embodiment of the present invention;

FIG. 1E is a view showing a step of a method for producing a filtration filter according to the first embodiment of the present invention;

FIG. 1F is a view showing a step of a method for producing a filtration filter according to the first embodiment of the present invention;

FIG. 2A is a view showing a step of a method for producing a filtration filter according to a second embodiment of the present invention;

FIG. 2B is a view showing a step of a method for producing a filtration filter according to the second embodiment of the present invention;

FIG. 2C is a view showing a step of a method for producing a filtration filter according to the second embodiment of the present invention;

FIG. 3A is a view showing a step of a method for producing a filtration filter according to a third embodiment of the present invention;

FIG. 3B is a view showing a step of a method for producing a filtration filter according to the third embodiment of the present invention;

FIG. 3C is a view showing a step of a method for producing a filtration filter according to the third embodiment of the present invention;

FIG. 3D is a view showing a step of a method for producing a filtration filter according to the third embodiment of the present invention;

FIG. 4A is a view showing a step of a method for producing a filtration filter according to a fourth embodiment of the present invention;

FIG. 4B is a view showing a step of a method for producing a filtration filter according to the fourth embodiment of the present invention;

FIG. 4C is a view showing a step of a method for producing a filtration filter according to the fourth embodiment of the present invention;

FIG. 4D is a view showing a step of a method for producing a filtration filter according to the fourth embodiment of the present invention;

FIG. 4E is a view showing a step of a method for producing a filtration filter according to the fourth embodiment of the present invention;

FIG. 4F is a view showing a step of a method for producing a filtration filter according to the fourth embodiment of the present invention;

FIG. 4G is a view showing a step of a method for producing a filtration filter according to the fourth embodiment of the present invention;

FIG. 4H is a view showing a step of a method for producing a filtration filter according to the fourth embodiment of the present invention;

FIG. 4I is a view showing a step of a method for producing a filtration filter according to the fourth embodiment of the present invention;

FIG. 4J is a view showing a step of a method for producing a filtration filter according to the fourth embodiment of the present invention;

FIG. 4K is a view showing a step of a method for producing a filtration filter according to the fourth embodiment of the present invention;

FIG. 4L is a view showing a step of a method for producing a filtration filter according to the fourth embodiment of the present invention;

FIG. 4M is a view showing a step of a method for producing a filtration filter according to the fourth embodiment of the present invention;

FIG. 5A is a view showing a step of a method for producing a filtration filter according to a fifth embodiment of the present invention;

FIG. 5B is a view showing a step of a method for producing a filtration filter according to the fifth embodiment of the present invention;

FIG. 5C is a view showing a step of a method for producing a filtration filter according to the fifth embodiment of the present invention;

FIG. 5D is a view showing a step of a method for producing a filtration filter according to the fifth embodiment of the present invention;

FIG. 5E is a view showing a step of a method for producing a filtration filter according to the fifth embodiment of the present invention;

FIG. 5F is a view showing a step of a method for producing a filtration filter according to the fifth embodiment of the present invention;

FIG. 5G is a view showing a step of a method for producing a filtration filter according to the fifth embodiment of the present invention;

FIG. 5H is a view showing a step of a method for producing a filtration filter according to the fifth embodiment of the present invention;

FIG. 5I is a view showing a step of a method for producing a filtration filter according to the fifth embodiment of the present invention;

FIG. 5J is a view showing a step of a method for producing a filtration filter according to the fifth embodiment of the present invention;

FIG. 5K is a view showing a step of a method for producing a filtration filter according to the fifth embodiment of the present invention;

FIG. 5L is a view showing a step of a method for producing a filtration filter according to the fifth embodiment of the present invention;

FIG. 5M is a view showing a step of a method for producing a filtration filter according to the fifth embodiment of the present invention;

FIG. 5N is a view showing a step of a method for producing a filtration filter according to the fifth embodiment of the present invention;

FIG. 6A is a view showing a step of a method for producing a filtration filter according to a sixth embodiment of the present invention;

FIG. 6B is a view showing a step of a method for producing a filtration filter according to the sixth embodiment of the present invention;

FIG. 6C is a view showing a step of a method for producing a filtration filter according to the sixth embodiment of the present invention;

FIG. 6D is a view showing a step of a method for producing a filtration filter according to the sixth embodiment of the present invention;

FIG. 6E is a view showing a step of a method for producing a filtration filter according to the sixth embodiment of the present invention;

FIG. 7A is a view showing a step of a method for producing a filtration filter according to a modified example of the sixth embodiment of the present invention;

FIG. 7B is a view showing a step of a method for producing a filtration filter according to the modified example of the sixth embodiment of the present invention;

FIG. 7C is a view showing a step of a method for producing a filtration filter according to the modified example of the sixth embodiment of the present invention;

FIG. 7D is a view showing a step of a method for producing a filtration filter according to the modified example of the sixth embodiment of the present invention;

FIG. 7E is a view showing a step of a method for producing a filtration filter according to the modified example of the sixth embodiment of the present invention;

FIG. 7F is a view showing a step of a method for producing a filtration filter according to the modified example of the sixth embodiment of the present invention;

FIG. 7G is a view showing a step of a method for producing a filtration filter according to the modified example of the sixth embodiment of the present invention;

FIG. 8 is a cross-sectional view showing a modified example of a filtration filter produced by a method for producing a filtration filter according to the sixth embodiment of the present invention;

FIG. 9 is a view showing a step of a method for producing a filtration filter according to a seventh embodiment of the present invention;

FIG. 10A is a view showing a step of a method for producing a filtration filter according to an eighth embodiment of the present invention;

FIG. 10B is a view showing a step of a method for producing a filtration filter according to the eighth embodiment of the present invention;

FIG. 10C is a view showing a step of a method for producing a filtration filter according to the eighth embodiment of the present invention;

FIG. 11A is a view showing a step of a method for producing a filtration filter according to a first modified example of the eighth embodiment of the present invention;

FIG. 11B is a view showing a step of a method for producing a filtration filter according to the first modified example of the eighth embodiment of the present invention;

FIG. 12A is a view showing a step of a method for producing a filtration filter according to a second modified example of the eighth embodiment of the present invention;

FIG. 12B is a view showing a step of a method for producing a filtration filter according to the second modified example of the eighth embodiment of the present invention;

FIG. 13 is a view showing a step of a method for producing a filtration filter according to a ninth embodiment of the present invention;

FIG. 14 is a view showing a step of a method for producing a filtration filter according to a tenth embodiment of the present invention;

FIG. 15 is a view showing a first modified example of a substrate to be used in a method for producing a filtration filter according to the present invention;

FIG. 16A is a view showing a second modified example of a substrate to be used in a method for producing a filtration filter according to the present invention; and

FIG. 16B is a view showing a third modified example of a substrate to be used in a method for producing a filtration filter according to the present invention.

### DETAILED DESCRIPTION OF THE EMBODIMENTS

The embodiments will now be described with reference to the accompanying drawings, wherein like reference numerals designate corresponding or identical elements throughout the various drawings.

First, a method for producing a filtration filter is described according to a first embodiment of the present invention.

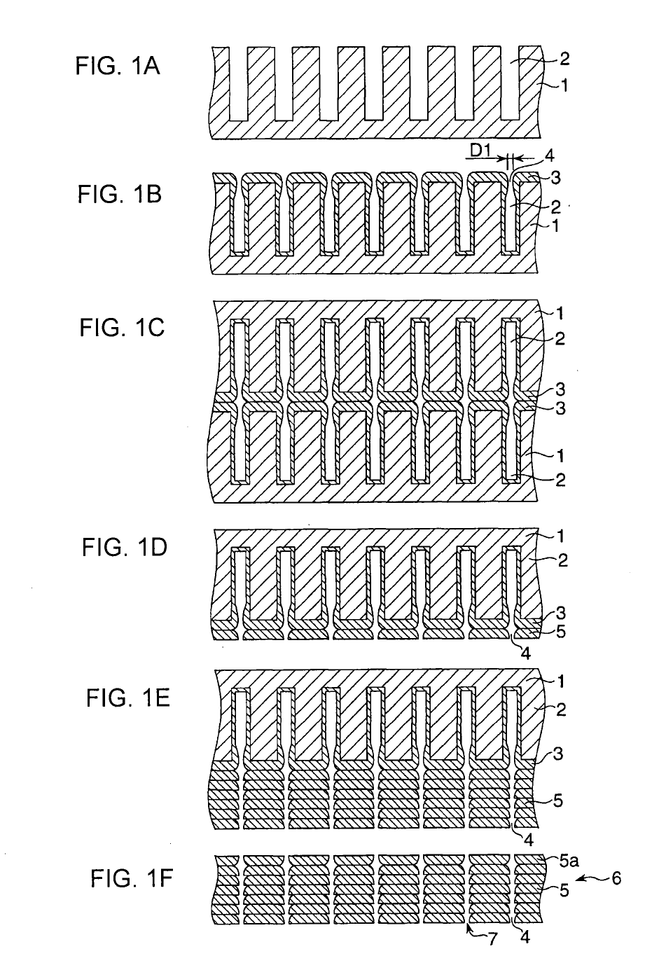

FIGS. 1A˜1F are views showing steps of a method for producing a filtration filter according to the first embodiment of the present invention.

In FIGS. 1A˜1F, plasma etching, for example, is conducted on silicon substrate 1 using masking film formed on a surface of substrate 1 and having numerous opening portions to expose portions of the surface. In the present embodiment, since each opening portion of the masking film is shaped to be a circle with an approximate diameter of 100 nm˜1 μm, numerous circular holes 2 with an approximate diameter of 100 nm˜1 μm are formed in substrate 1 (FIG. 1A).

Next, silica film 3 is deposited on the surface of substrate 1 and inner surfaces of circular holes 2 by CVD (Chemical Vapor Deposition) using thermal oxidation. During that time, more silica film 3 is deposited near the opening end than inside circular hole 2, making the actual diameter of circular hole 2 the smallest near the opening end (FIG. 1B). In the present embodiment, CVD treatment duration is adjusted so that diameter (D1) at minimum-diameter portion 4 near the opening end of circular hole 2 is reduced to be 1 nm˜100 nm by silica film 3.

Next, silica films 3 of two substrates 1, where the diameter of circular holes 2 is reduced by silica film 3, make contact with each other, and the temperature of the ambient atmosphere is raised to 400° C.˜1000° C. so that silica films 3 are thermally bonded. At that time, two substrates 1 are laminated so that the position of each circular hole 2 in upper substrate 1 in the drawing is aligned with the position of each circular hole 2 in lower substrate 1 in the drawing (FIG. 1C).

Next, the lower surface of lower substrate 1 in the drawing is polished by CMP (chemical mechanical polishing) or the like to remove the silicon portion of that substrate 1 so that diameter-adjustment portion 5 made only of silica film 3 remains in lower substrate 1 in the drawing. At that time, the silicon portion is removed so that minimum-diameter portion 4 remains in diameter-adjustment portion 5 (FIG. 1D).

Next, lamination of substrates 1 shown in FIG. 1C and polishing of substrates shown in FIG. 1D are repeated until at least 10 or more layers of diameter-adjustment portion 5, more preferably 100 or more layers, are laminated (FIG. 1E). Then, the lower surface of upper substrate 1 in the drawing is polished by CMP or the like to remove the silicon portion of that substrate 1 so that diameter-adjustment portion (5a) made only of silica film 3 remains in upper substrate 1 in the drawing. Accordingly, filtration filter 6 is formed as a reverse osmosis membrane, completing the present process (FIG. 1F).

In filtration filter 6, flow channels 7 are formed by connecting minimum-diameter portions 4 of diameter-adjustment portions 5, making the minimum diameter of flow channels 7 to be 1 nm˜100 nm. Accordingly, filtration filter 6 is used to remove vibrio cholerae and typhoid bacillus with a size of a few hundred nanometers by flowing sewage or seawater through flow channels 7. Moreover, if the minimum diameter of flow channels 7 is controlled to be 1 nm˜5 nm, not only contaminants and salt content but also picornaviruses and parvoviruses with an approximate size of 20 nm are removed.

In the present embodiment, diameter-adjustment portions 5 are laminated downward by polishing the lower surface of lower substrate 1 in FIG. 1D. However, diameter-adjustment portions 5 may also be laminated upward by polishing the lower surface of upper substrate 1.

According to the method for producing a filtration filter of the present embodiment, the diameter of numerous circular holes formed in substrate 1 is directly controlled by adjusting the diameter of the opening portions of masking film. Accordingly, when forming circular holes 2 with a diameter of a few nanometers˜100 nm, irregularities are prevented in the diameter of circular holes 2. As a result, by selecting the hole diameters, vibrio cholerae with a size of a few hundred nanometers, viruses with a size of a few dozen nanometers and contaminants are prevented from passing through substrate 1, and a combined use of a distillation method or the like is not required when producing clean water or freshwater purified by filtration filter 6 formed by laminating substrates 1. Thus, procedures for obtaining clean water or freshwater are simplified. Also, since filtration filter 6 is made of rigid silica film 3, primary pressure applied on sewage or seawater can be increased, improving the purification efficiency of producing clean water or freshwater.

In the above-described method for producing a filtration filter according to the present embodiment, silica is deposited by CVD. Since the deposition amount is adjustable by adjusting the CVD treatment duration, it is easy to set the diameter of circular holes 2 at a required value.

Also, in the above-described method for producing a filtration filter according to the present embodiment, since the lower surface of substrate 1 is polished after numerous circular holes 2 are formed in substrate 1, each circular hole will surely penetrate through substrate 1 by adjusting the polishing amount.

Moreover, in the above-described method for producing a filtration filter according to the present embodiment, since 10 or more layers of diameter-adjustment portions 5 are laminated, the strength of filtration filter 6 is enhanced.

In the above-described method for producing a filtration filter according to the present embodiment, silica film 3 is formed on a surface of substrate 1, and silica film 3 on each substrate 1 is thermally bonded to each other when two substrates 1 are laminated. Thus, substrates 1 are firmly bonded to each other, further improving the strength of filtration filter 6.

In the above-described method for producing a filtration filter according to the present embodiment, plasma etching is conducted on substrates. However, any other etching method may be employed as long as openings of masking film are accurately transcribed to a substrate.

In the above-described method for producing a filtration filter according to the present embodiment, silica film 3 is deposited on a surface of substrate 1 and inner surfaces of circular holes 2 by CVD. However, as long as it can be deposited by CVD, it may be any rigid film such as silicon-nitride film, polysilicon film or the like. Although silicon is used for substrate 1, metal or metal oxide may also be used to form substrate 1 as long as it is a rigid material that can be etched. Also, CVD by thermal oxidation is used when depositing silica film 3, but plasma CVD may also be used.

In the above-described method for producing a filtration filter according to the present embodiment, minimum-diameter portion 4 is included in all diameter-adjustment portions 5 of flow channel 7. However, minimum-diameter portion 4 is not required for all diameter-adjustment portions 5, and it is an option that only one diameter-adjustment portion 5 of flow channel 7 has minimum-diameter portion 4.

Moreover, in the above-described method for producing a filtration filter according to the present embodiment, the entire silicon portion is removed from each substrate 1. However, it is not always required to remove the entire silicon portion. It is sufficient if the silicon portion is removed to such a degree that at least circular holes 2 penetrate through substrate 1.

In the above-described method for producing a filtration filter according to the present embodiment, circular holes 2 are formed in each substrate 1. However, each opening portion of masking film may be formed as a slit so that grooves are formed in substrate 1 through etching by using such opening portions. In such a case, it is preferred to adjust the minimum width of grooves at 1 nm˜100 nm, more preferably at 1 nm˜5 nm, by depositing silica on the inner surfaces of the grooves.

Next, a method for producing a filtration filter is described according to a second embodiment of the present invention.

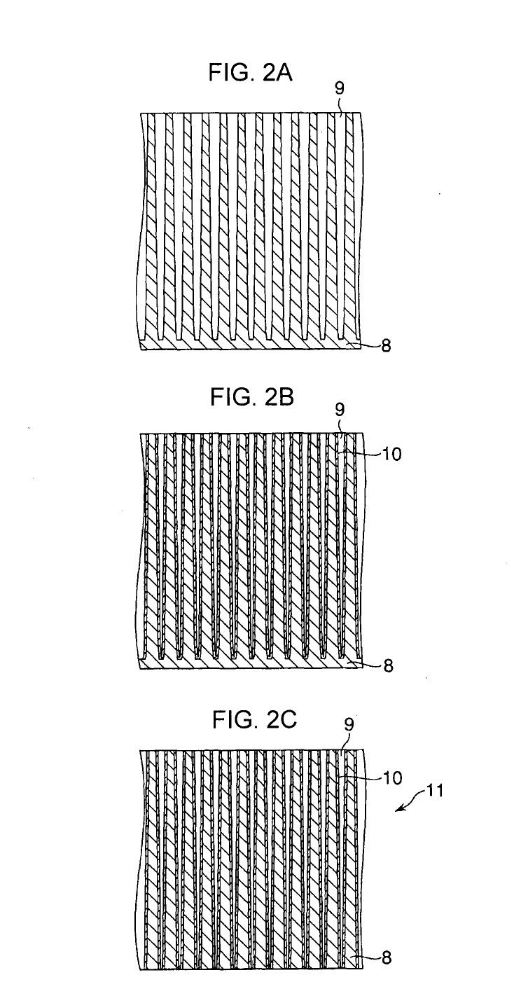

FIGS. 2A˜2C are views showing steps of a method for producing a filtration filter according to a second embodiment of the present invention.

In FIGS. 2A˜2C, first, using masking film formed on a surface of silicon substrate 8 and having numerous opening portions to expose portions of the surface, substrate 8 is etched so that numerous DTs (deep trenches) 9 are formed. In the present embodiment, plasma etching capable of high anisotropic etching is preferred so that DTs with a high aspect ratio are formed.

In the present embodiment, since each opening portion of the masking film is made into a slit shape with an approximate width of 20 nm˜40 nm, numerous DTs 9 with an approximate width of 20 nm˜40 nm are formed in substrate 8 (FIG. 2A). Usually, DTs with an aspect ratio of 10 or greater have narrowed tip portions. In DTs 9 of the present embodiment, the width of the tip portions is approximately 10 nm.

Next, silica film 10 is deposited on a surface of substrate 8 and on inner surfaces of DTs 9 through ALD (Atomic Layer Deposition), and only the silica 10 deposited on the surface of substrate 8 is further removed (FIG. 2B). In the present embodiment, the ALD treatment duration is adjusted so that minimum width (D1) at tip portions of DTs 9 is set at 1 nm˜5 nm, preferably at 1 nm˜3 nm.

Next, a lower surface of substrate 8 is polished by CMP or the like, and such polishing is stopped when the tip portions of DTs 9 are exposed at the lower surface of substrate 8. In doing so, filtration filter 11 is formed when each DT 9 penetrates through substrate 8 (FIG. 2C). Accordingly, the present process is completed.

In filtration filter 11, minimum width (D1) of DTs 9 penetrating through substrate 8 is set at 1 nm˜5 nm. Thus, when sewage or seawater flows through DTs 9 of filtration filter 11, not only contaminants and salt content but also picornaviruses and parvoviruses with an approximate size of 20 nm are removed.

In the method for producing a filtration filter according to the present embodiment, silica film is deposited through ALD. Since ALD can deposit by a unit of one atom, minimum width (D1) at tip portions of DTs 9 is adjusted precisely at a required value.

In the above-described method for producing a filtration filter according to the present embodiment, DTs 9 were formed in substrate 8. However, each opening portion of masking film may be formed in a circular shape so that circular holes are formed in substrate 8 through etching by using such opening portions. In such a case, it is preferred to adjust the minimum diameter of circular holes to be 1 nm˜5 nm by depositing silica on the inner surfaces of circular holes.

When removing vibrio cholerae, typhoid bacillus and the like with a size of a few hundred nanometers, minimum width (D1) of DTs 9 or the minimum diameter of penetrating holes may be set at 1 nm˜100 nm. Except that the opening size for forming such DTs is roughly 100 nm˜1 μm, the method is not different from that for forming DTs 9 with minimum width (D1) of 1 nm˜5 nm.

The method for producing a filtration filter according to the present embodiment has the same effects as the method for producing a filtration filter according to the above-described first embodiment.

Next, a method for producing a filtration filter is described according to a third embodiment of the present invention.

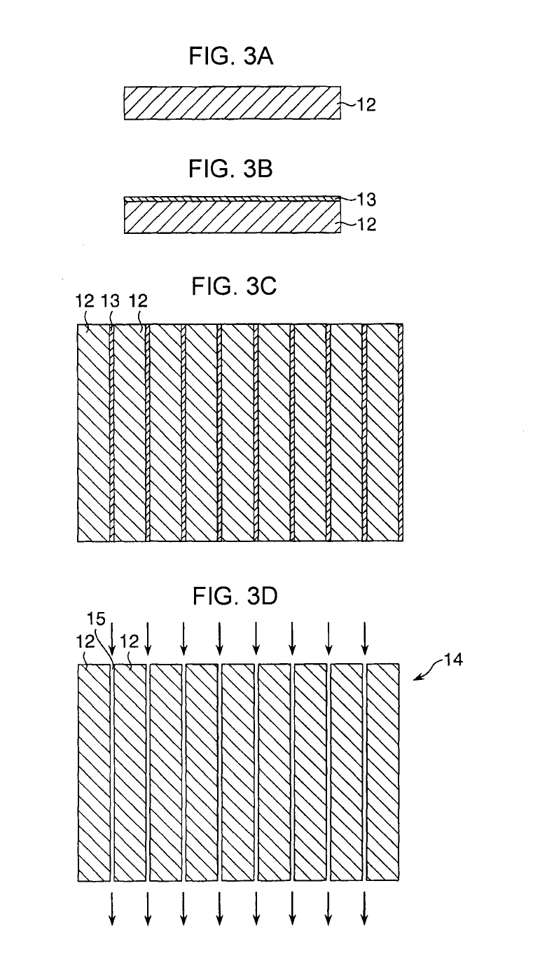

FIGS. 3A˜3D are views showing steps of a method for producing a filtration filter according to a third embodiment of the present invention.

In FIGS. 3A˜3D, first, silicon substrate 12 is prepared (FIG. 3A), and amorphous carbon film 13 with a thickness of 1 nm˜100 nm is deposited on a surface of substrate 12 (FIG. 3B).

Next, multiple substrates 12 are laminated in such a way that amorphous carbon film 13 of one substrate 12 makes contact with a lower surface of another substrate 12, their peripheral borders are secured by a frame (not shown) or the like (FIG. 3C), and each amorphous carbon film 13 is removed by ashing. Accordingly, filtration filter 14 is formed as a reverse osmosis membrane (FIG. 3D), completing the present process.

In filtration filter 14, slit-shaped flow channel 15 is formed between two adjacent substrates 12 after each amorphous carbon film 13 is removed, and the width of flow channel 15 is 1 nm˜100 nm. When sewage or seawater flows through flow channels 15 in a direction indicated by arrows in the drawing, vibrio cholerae, typhoid bacillus and the like with a size of a few hundred nanometers are removed by filtration filter 14. Moreover, by controlling the width of flow channels 15 to be 1 nm˜5 nm, not only contaminants and salt content but also picornaviruses and parvoviruses with an approximate size of 20 nm are removed.

According to the method for producing a filtration filter of the present embodiment, after multiple silicon substrates 12 are laminated by means of amorphous carbon film 13 to set their distance at 1 nm˜100 nm, each amorphous carbon film 13 is removed. Thus, the width of slit-shaped flow channel 15 formed between adjacent substrates 12 is directly controlled, preventing irregularities in the width of slit-shaped flow channels.

Also, in the above-described method for producing a filtration filter according to the present embodiment, since slit-shaped flow channels 15 with a width of 1 nm˜100 nm are used for filtration, a greater amount of sewage or seawater can flow through flow channels 15 than when using circular holes with a minimum diameter of 1 nm˜100 nm for filtration. As a result, the purification efficiency of producing clean water or freshwater is enhanced.

Moreover, in the above-described method for producing a filtration filter according to the present embodiment, the distance between adjacent substrates 12 is maintained when the peripheral borders of multiple substrates 12 are secured by a frame or the like. However, pillar-shaped distance retainers with a height of 1 nm˜100 nm may be placed between adjacent substrates 12 so that the distance is maintained between adjacent substrates 12.

In the above-described method for producing a filtration filter according to the present embodiment, each amorphous carbon film 13 is removed by ashing. However, each amorphous carbon film 13 may be removed by wet etching using a supercritical chemical solution or the like. Since supercritical chemical solutions enter fine space smoothly, each amorphous carbon film 13 is surely removed.

The method for producing a filtration filter according to the present embodiment has the same effects as the method for producing a filtration filter according to the above-described first embodiment.

Next, a method for producing a filtration filter is described according to a fourth embodiment of the present invention.

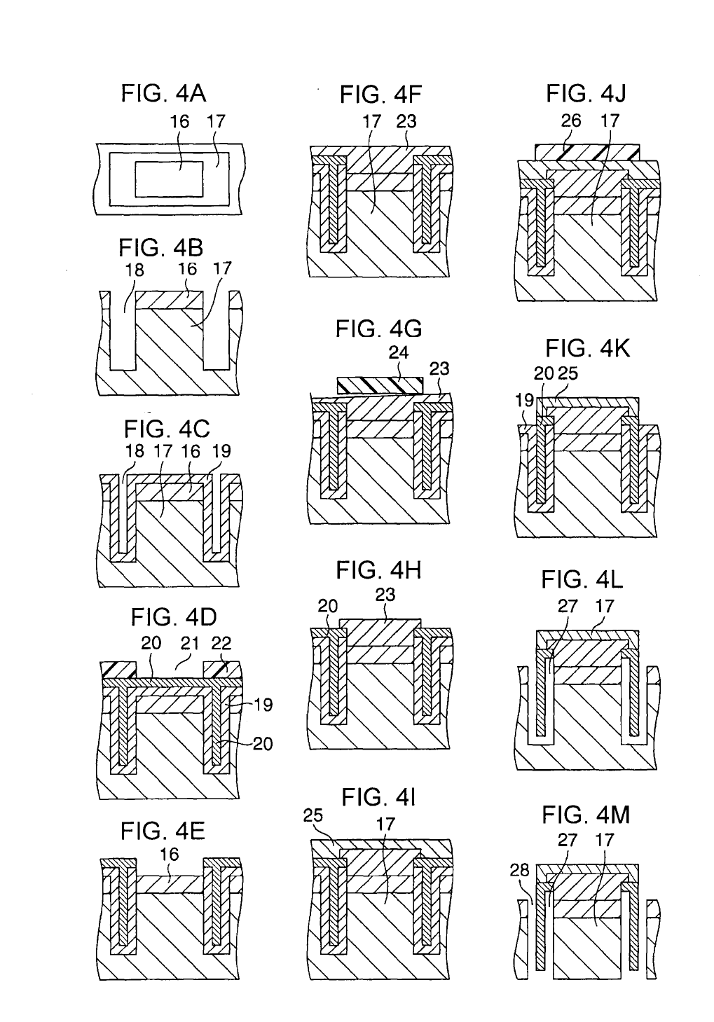

FIGS. 4A˜4M are views showing steps of a method for producing a filtration filter according to a fourth embodiment of the present invention.

In FIGS. 4A˜4M, first, silicon substrate 17 with silicon-nitride film 16 formed on its surface is etched using masking film formed on a surface of substrate 17 and having opening portions to expose portions of the surface so that trenches 18 with an approximate width of 10 nm˜300 nm are formed in substrate 17 (FIGS. 4A, 4B). Here, FIG. 4A is a plan view.

Next, amorphous carbon film 19 with a thickness of 1 nm-100 nm is deposited on a surface of substrate 17 and inner surfaces of trenches 18 (FIG. 4C).

Next, the surface of substrate 17 is made flat by depositing silica film 20 through CVD on inner surfaces of trenches 18 and the surface of substrate 17, and photoresist film 22 having opening portions 21 is further formed on the flat surface of substrate 17 (FIG. 4D). Amorphous carbon film 19 in trenches 18 is covered accordingly by silica film 20 during that time.

Next, using photoresist film 22 as masking film, portions of silica film 20 and amorphous carbon film 19 are etched away to expose silicon-nitride film 16 (FIG. 4E), the entire surface of substrate 17 is covered by silicon-nitride film 23 through CVD (FIG. 4F), and photoresist film 24 is further formed covering portions of the surface of substrate 17 (FIG. 4G).

Next, using photoresist film 24 as masking film, portions of silicon-nitride film 23 are etched away to expose silica film 20 (FIG. 4H), the entire surface of substrate 17 is covered by silicon-nitride film 25 through CVD (FIG. 4I), and photoresist film 26 is further formed covering portions of the surface of substrate 17 (FIG. 4J).

Next, using photoresist film 26 as masking film, portions of silicon-nitride film 25 and silica film 20 are etched away to expose portions of amorphous carbon film 19 (FIG. 4K), and the entire amorphous carbon film 19 is removed by ashing so that hollows 27 with a U-shaped cross section and with a width of 1 nm˜100 nm are formed in substrate 17 (FIG. 4L).

Next, the lower surface of substrate 17 is polished by CMP or the like, and such polishing is stopped when hollows 27 are exposed at the lower surface of substrate 17. In doing so, flow channels 28 with a width of 1 nm˜100 nm are formed, penetrating through substrate 17 in a thickness direction (FIG. 4M). Accordingly, the present process is completed.

According to the method for producing a filtration filter of the present embodiment, amorphous carbon film 19 with a thickness of 1 nm˜100 nm is deposited on inner surfaces of trenches 18, and amorphous carbon film 19 is removed after it is covered by silica film 20 so that flow channels 28 with a width of 1 nm˜100 nm are formed. When sewage or seawater flows through flow channels 28, vibrio cholerae, typhoid bacillus and the like are removed. Also, by controlling the width of flow channels 28 at 1 nm˜5 nm, contaminants, salt content and even viruses are removed. Therefore, without a combined use of a distillation method or the like, clean water or freshwater is obtained.

In the above-described method for producing a filtration filter of the present embodiment, trenches 18 are formed in substrate 17. However, circular holes may be formed in substrate 17. In such a case, amorphous carbon film 19 is deposited on the inner surfaces of the circular holes, and such amorphous carbon film 19 is removed in a later step so that flow channels in a circular shape are formed.

The method for producing a filtration filter according to the present embodiment has the same effects as the method for producing a filtration filter according to the above-described first embodiment.

Next, a method for producing a filtration filter is described according to a fifth embodiment of the present invention.

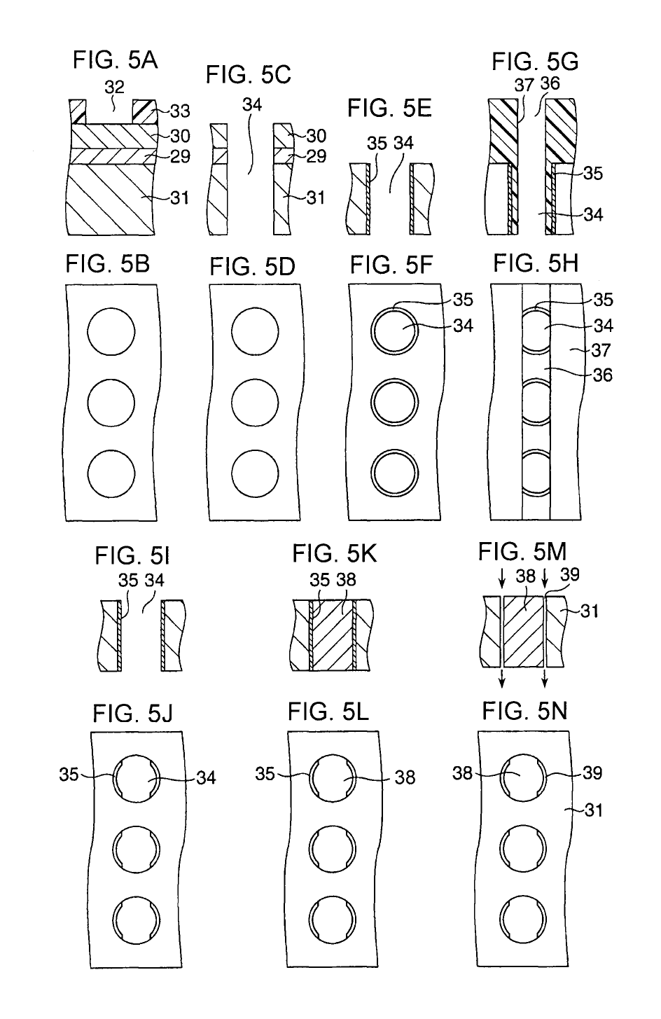

FIGS. 5A˜5N are views showing steps of a method for producing a filtration filter according to a fifth embodiment of the present invention. FIGS. 5B, 5D, 5F, 5H, 5J, 5L and 5N are plan views.

In FIGS. 5A˜5N, first, silicon substrate 31 with silicon-nitride film 29 and silica film 30 formed on its surface is covered by photoresist film 33 having multiple circular opening portions 32 with an approximate diameter of 10 nm˜300 nm (FIGS. 5A, 5B). Using photoresist film 33 as masking film, silicon-nitride film 29, silica film 30 and substrate 31 are etched so that multiple circular holes 34 with an approximate diameter of 10 nm˜300 nm are formed in substrate 31 (FIGS. 5C, 5D).

Next, silicon-nitride film 29 and silica film 30 are removed by etching or the like, and amorphous carbon film 35 with a thickness of 1 nm˜100 nm is deposited on the inner surfaces of circular holes 34 (FIGS. 5E, 5F). Furthermore, photoresist film 37, which covers part of circular holes 34 and amorphous carbon film 35 in a planar view and has slit-shaped opening portions 36, is formed on a surface of substrate 31 (FIGS. 5G, 5H), amorphous carbon film 35 exposed from photoresist film 37 as masking film is removed by ashing, and remaining photoresist film 37 is further removed by ashing or the like. Accordingly, amorphous film 35 shaped like a “C” in a planar view remains on the inner surfaces of circular holes 34 (FIGS. 5I, 5J).

Next, circular holes 34 are filled with silica 38 through CVD (FIGS. 5K, 5L). During that time, amorphous carbon film 35 in circular holes 34 is covered accordingly by silica 38. Then, remaining amorphous carbon film 35 is removed by ashing. Accordingly, flow channels 39 sandwiched by substrate 31 and silica 38 and shaped like a “C” in a planar view are formed (FIGS. 5M, 5N). The present process is completed.

According to the method for producing a filtration filter of the present embodiment, after amorphous carbon film 35 with a thickness of 1 nm˜100 nm is deposited on the inner surfaces of circular holes 34 and then covered by silica 38, the amorphous carbon film 35 is removed. Thus, flow channels 39 with a width of 1 nm˜100 nm are formed. When sewage or seawater flows through flow channels 39 in a direction indicated by arrows in the drawing, vibrio cholera, typhoid bacillus, contaminants, salt content and viruses are removed. Accordingly, a combined use of a distillation method or the like is not required to produce clean water or freshwater.

The method for producing a filtration filter according to the present embodiment has the same effects as the method for producing a filtration filter according to the above-described first embodiment.

Next, a method for producing a filtration filter is described according to a sixth embodiment of the present invention.

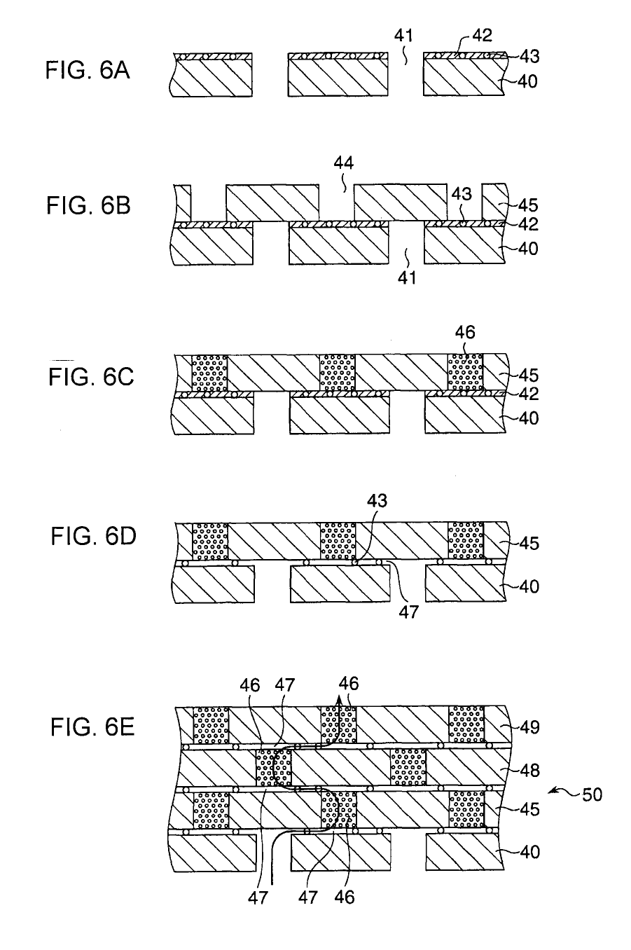

FIGS. 6A˜6E are views showing steps of a method for producing a filtration filter according to a sixth embodiment of the present invention.

In FIGS. 6A˜6E, first, by etching silicon substrate 40 using masking film formed on a surface of substrate 40 and having numerous opening portions to expose portions of the surface, multiple penetrating holes 41 with a diameter of a few dozen nanometers to 300 nm are formed. Then, amorphous carbon film 42 is formed on a surface of substrate 40. Amorphous carbon film 42 includes numerous distance retainers with a size of 1 nm˜100 nm, for example, micropillars 43 with a height of 1 nm˜100 nm (FIG. 6A).

Next, substrate 45 having multiple penetrating holes 44 with a diameter of a few dozen nanometers to 300 nm is formed by etching the same as substrate 40 using masking film. Then, substrate 45 is compressed and laminated to substrate 40 by means of amorphous carbon film 42, and the substrates are further bonded. Although amorphous carbon film 42 is squeezed to be compressed in a thickness direction during that time, micropillars 43 are not compressed. Thus, the distance between substrate 40 and substrate 45 is maintained at 1 nm˜100 nm (FIG. 6B). Here, substrate 45 is laminated to substrate 40 in such a way that penetrating holes 44 do not align with penetrating holes 41 in a planar view.

Next, porous ceramic material 46 is fully filled in each penetrating hole 44 through PVD (physical vapor deposition) (FIG. 6C), and amorphous carbon film 42 is removed by ashing to form gap 47 between substrate 40 and substrate 45 (FIG. 6D). Here, since micropillars 43 exist between substrates 40 and 45 as described above, the thickness of gap 47 is the same as the height of micropillars 43.

Next, after amorphous carbon film 42 is formed on a surface of substrate 45, the above-described steps shown in FIGS. 6B through 6D along with a step for forming amorphous carbon film on the surface of the uppermost substrate are repeated so that substrates 48 and 49 having the same structure as substrate 45 are laminated in that order on substrate 45. During such time, substrates 48 and 49 are laminated on substrate 45 in such a way that penetrating holes of adjacent substrates do not align in a planar view. In addition, each amorphous carbon film 42 between substrates is removed by ashing every time a substrate is laminated. Accordingly, filtration filter 50 is formed as a reverse osmosis membrane (FIG. 6E), completing the present process.

In filtration filter 50, gaps 47 with a thickness of 1 nm˜100 nm, which are formed when each amorphous carbon film is removed, work as flow channels, and sewage or seawater flows through ceramic material 46 and gaps 47 in a direction indicated by an arrow in the drawing. Thus, vibrio cholerae, typhoid bacillus and the like with a size of a few hundred nanometers are removed by gaps 47. Moreover, by controlling gaps 47 to be 1 nm˜5 nm, not only contaminants or salt content but also picornaviruses and parvoviruses with an approximate size of 20 nm are removed.

According to the method for producing a filtration filter of the present embodiment, since amorphous carbon film 42 includes micropillars 43 with a height of 1 nm˜100 nm, the thickness of gaps 47 is securely maintained at 1 nm˜100 nm by micropillars 43 even after amorphous carbon film 42 is removed.

In the above-described method for producing a filtration filter according to the present embodiment, substrates are laminated in such a way that the penetrating holes of each substrate do not align with each other in a planar view. Thus, ceramic material 46 of each substrate is prevented from aligning with each other to form penetrating holes made only of ceramic material 46. Accordingly, vibrio cholerae and typhoid bacillus with a size of a few hundred nanometers, viruses with a size of a few dozen nanometers and contaminants are prevented from passing through filtration filter 50 in a thickness direction.

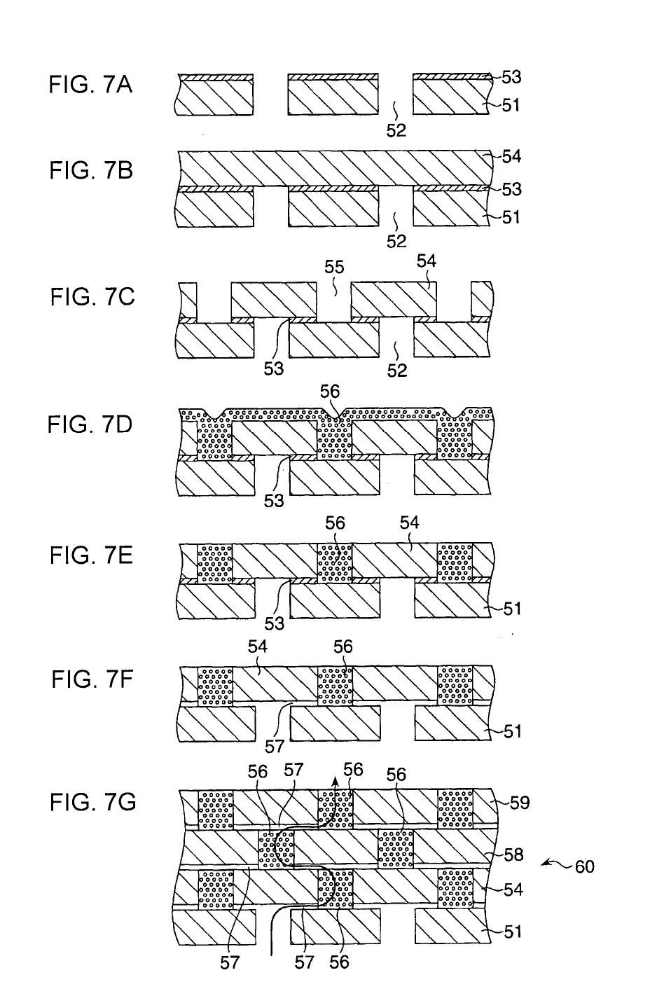

FIGS. 7A˜7G are views showing a method for producing a filtration filter according to a modified example of the sixth embodiment of the present invention.

In FIGS. 7A˜7G, first, by etching silicon substrate 51 using masking film formed on a surface of substrate 51 and having numerous opening portions to expose portions of the surface, multiple penetrating holes 52 with a diameter of a few dozen nanometers to 300 nm are formed. Then, amorphous carbon film 53 with a thickness of 1 nm˜100 nm is further formed on the surface of substrate 51 (FIG. 7A).

Next, silicon substrate 54 is laminated on substrate 51 and bonded by means of amorphous carbon film 53 (FIG. 7B), and by etching substrate 54 using masking film formed on a surface of substrate 54 and having numerous opening holes to expose portions of the surface, multiple penetrating holes 55 with a diameter of a few dozen nanometers to 300 nm are formed. At that time, penetrating holes 55 are formed not to align with penetrating holes 52 of substrate 51 in a planar view. Also, amorphous carbon film 53 is removed from the bottom of each penetrating hole 55 (FIG. 7C).

Next, a surface of substrate 54 is covered by porous ceramic material 56 through PVD and penetrating holes 55 are filled with ceramic material 56 (FIG. 7D). Ceramic material 56 in penetrating holes 55 are naturally bonded to substrates 51 and 54. Then, ceramic material 56 deposited on the surface of substrate 54 during PVD is removed by polishing or the like (FIG. 7E).

Next, amorphous carbon film 53 is removed by ashing. Here, since ceramic material 56 in each penetrating hole 55 is bonded with substrates 51 and 54, substrates 51 and 54 will not be separated from each other. Ceramic material 56 prevents substrates 51 and 54 from touching each other, and gap 57 with a thickness of 1 nm˜100 nm is formed between substrates 51 and 54 (FIG. 7F).

Next, after amorphous carbon film 53 is formed on a surface of substrate 54, the above-described steps shown in FIGS. 7B through 7F along with a step for forming amorphous carbon film on the surface of the uppermost substrate are repeated so that substrates 58 and 59 having the same structure as substrate 54 are laminated in that order on substrate 54. During that time, penetrating holes of each substrate are formed not to align with each other in a planar view. In addition, each amorphous carbon film 53 between substrates is removed by ashing every time a substrate is laminated. Accordingly, filtration filter 60 is formed as a reverse osmosis membrane (FIG. 7G), completing the present process.

In filtration filter 60, porous ceramic material 56 and gaps 57 with a thickness of 1 nm˜100 nm, which are formed when each amorphous carbon film is removed, work as flow channels. Since sewage or seawater flows through ceramic material 56 and gaps 57 in a direction indicated by an arrow in the drawing, not only contaminants or salt content but also picornaviruses and parvoviruses with an approximate size of 20 nm are removed by gaps 57.

In the method for producing a filtration filter according to the present modified example, penetrating holes of each substrate are also formed not to align with each other in a planar view. Thus, ceramic material 56 of each substrate is prevented from aligning with each other to form penetrating holes made only of ceramic material 56. Accordingly, vibrio cholerae and typhoid bacillus with a size of a few hundred nanometers, viruses with a size of a few dozen nanometers and contaminants are prevented from passing through filtration filter 60 in a thickness direction.

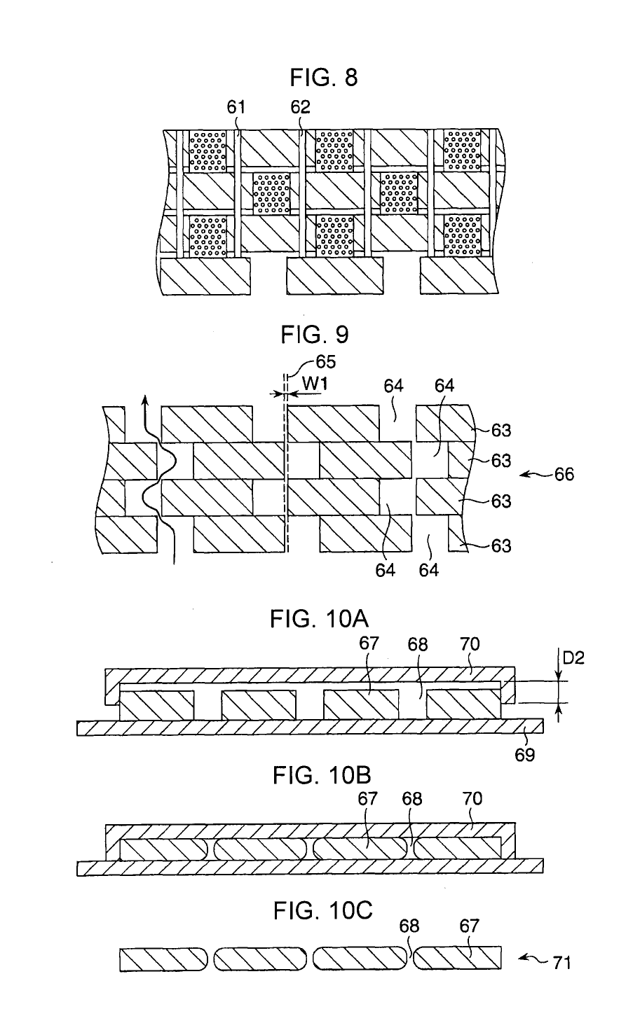

In the above-described filtration filters 50 and 60, multiple penetrating holes 61 are formed to go through each substrate (45, 48, 49 or 54, 58, 59) all at once, and a rigid member made of metal such as tungsten is inserted in each penetrating hole 61 to form pillars 62 which penetrate through filtration filter 50 or 60 in a thickness direction (FIG. 8). Accordingly, the strength of filtration filter 50 or 60 is also enhanced.

The method for producing a filtration filter according to the present embodiment has the same effects as the method for producing a filtration filter according to the above-described first embodiment.

FIG. 9 is a view showing a step in a method for producing a filtration filter according to a seventh embodiment of the present invention.

In FIG. 9, first, using masking film formed on a surface of each substrate 63 and having numerous opening portions to expose portions of the surface, multiple penetrating holes 64 with a diameter of a few dozen nanometers to 300 nm are formed in multiple silicon substrates 63 through etching. Then, when multiple substrates 63 are laminated and bonded, penetrating holes 64 of each substrate 63 align with each other in a planar view so that penetrating flow channels 65 are formed to penetrate through all the substrates 63 in a thickness direction. At that time, the overlapping amount of penetrating holes 64 is adjusted so that maximum width (W1) of penetrating flow channels 65 is 1 nm˜100 nm. Accordingly, filtration filter 66 is formed as a reverse osmosis membrane, completing the present process.

Since maximum width (W1) of penetrating flow channels 65 is 1 nm˜100 nm in filtration filter 66, vibrio cholerae and typhoid bacillus with a size of a few hundred nanometers are removed by flowing sewage or seawater through penetrating flow channels 65 of filtration filter 66 along a direction indicated by an arrow in the drawing. Moreover, by controlling minimum width (W1) of penetrating flow channels 65 at 1 nm˜5 nm, not only contaminants and salt content but also picornaviruses and parvoviruses with an approximate size of 20 nm are removed. Accordingly, clean water or freshwater is obtained without a combined use of a distillation method or the like.

The method for producing a filtration filter according to the present embodiment has the same effects as the method for producing a filtration filter according to the above-described first embodiment.

FIGS. 10A˜10C are views showing steps of a method for producing a filtration filter according to an eighth embodiment of the present invention.

In FIGS. 10A˜10C, first, substrate 67 made of CF polymer or DLC (diamond-like carbon) is etched using masking film formed on a surface of substrate 67 and having numerous opening portions to expose portions of the surface so that multiple penetrating holes 68 with an approximate diameter of 20˜200 nm are formed. Substrate 67 is placed on base plate 69 made of titanium or diamond, and substrate 67 is further covered by cover 70 made of titanium or diamond (FIG. 10A). Depth (D2) of cover 70 is set to be smaller than the thickness of substrate 67.

Next, cover 70 is compressed against base plate 69. At that time, substrate 67 is compressed in a thickness direction so as to be expanded in a horizontal direction. However, since its peripheral borders are covered by cover 70, each inner wall of penetrating holes 68 protrudes, reducing the diameter of penetrating holes 68 accordingly (FIG. 10B). In the present embodiment, the amount to compress substrate 67 is adjusted to set the reduced diameter of penetrating holes 68 at 1 nm˜100 nm.

Next, base plate 69 and cover 70 are removed from substrate 67, and filtration filter 71 is formed as a reverse osmosis membrane (FIG. 10C), completing the present process.

Since the diameter of penetrating holes 68 is 1 nm˜100 nm in filtration filter 71, not only contaminants and salt content but also picornaviruses and parvoviruses with an approximate size of 20 nm are removed by flowing sewage or seawater through penetrating holes 68 of filtration filter 71.

According to the method for producing a filtration filter of the present embodiment, the diameter of penetrating holes 68 is adjusted by compressing substrate 67 in a thickness direction so that penetrating holes 68 are deformed and the inner walls of penetrating holes 68 protrude. Thus, it is easy to produce filtration filter 71.

In the above-described method for producing a filtration filter according to the present embodiment, as long as the diameter of each penetrating hole 68 is set at 1 nm˜100 nm at maximum, it is acceptable if some penetrating holes 68 are blocked. Thus, the amount to compress substrate 67 is preferred to be set relatively great.

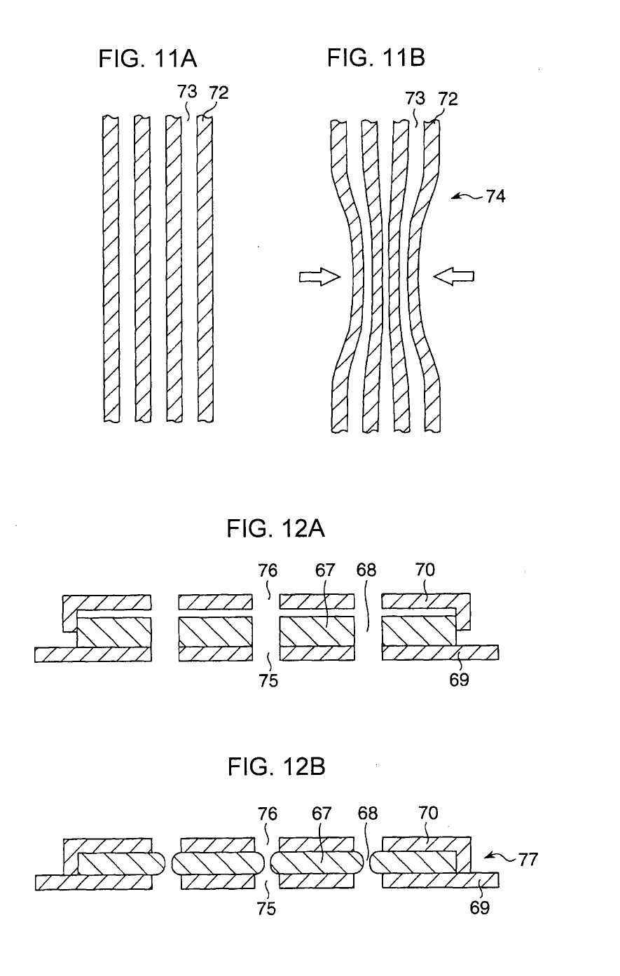

FIGS. 11A and 11B are views showing steps of a method for producing a filtration filter according to a first modified example of the eighth embodiment of the present invention.

FIGS. 11A and 11B, first, by etching long narrow base 72 made of CF polymer or DLC using masking film having numerous opening portions, multiple penetrating holes 73 with an approximate diameter of 20 nm˜200 nm are formed along a longitudinal direction of long narrow base 72 (FIG. 11A).

Next, long narrow base 72 is compressed sideways in a direction perpendicular to the direction of its length (directions indicated by arrows in the drawing). At that time, the inner wall of each penetrating hole 73 protrudes inside penetrating hole 73, resulting in a reduced diameter of penetrating hole 73 (FIG. 11B). In the present embodiment, the amount to compress long narrow base 72 is adjusted to set the reduced diameter of penetrating hole 73 at 1 nm˜100 nm. Accordingly, filtration filter 74 is formed as a reverse osmosis membrane, completing the present process.

Since the diameter of penetrating holes 73 is at 1 nm˜100 nm in filtration filter 74, vibrio cholerae and typhoid bacillus with a size of a few hundred nanometers are removed by flowing sewage or seawater through penetrating holes 73 of filtration filter 74. Moreover, the diameter of the penetrating holes is controlled to be 1 nm˜5 nm so that not only contaminants or salt content but also picornaviruses and parvoviruses with an approximate size of 20 nm are removed.

FIGS. 12A and 12B are views showing steps of a method for producing a filtration filter according to a second modified example of the eighth embodiment of the present invention.

In FIGS. 12A˜12B, first, using masking film formed on a surface of base plate 69 and having numerous opening portions to expose portions of the surface, base plate 69 is etched so that multiple penetrating holes 75 with an approximate diameter of 20 nm˜200 nm are formed, and using masking film formed on a surface of cover 70 and having numerous opening portions to expose portions of the surface, cover 70 is etched so that multiple penetrating holes 76 with an approximate diameter of 20 nm˜200 nm are formed. The same as the producing method shown in FIGS. 10A˜10C, substrate 67, which is etched in advance using masking film to have multiple penetrating holes 68 with an approximate diameter of 20 nm˜200 nm, is placed on base plate 69 and then covered by cover 70 (FIG. 12A). At that time, positions of base plate 69, substrate 67 and cover 70 are adjusted so that penetrating holes 75 of base plate 69, penetrating holes 68 of substrate 67 and penetrating holes 76 of cover 70 align with each other in a planar view.

Next, cover 70 is compressed against base plate 69. At that time, each inner wall of penetrating holes 68 protrudes, thus reducing the diameter of penetrating holes 68 accordingly (FIG. 12B). In the present embodiment as well, the amount to compress substrate 67 is adjusted so that the reduced diameter of penetrating holes 68 is set at 1 nm˜100 nm. Accordingly, filtration filter 77 is formed as a reverse filtration membrane without removing base plate 69 and cover 70 from substrate 67, completing the present process. In filtration filter 77, base plate 69 and cover 70 work as reinforcing material for substrate 67.

The method for producing a filtration filter according to the above-described present embodiment has the same effects as the method for producing a filtration filter according to the above-described first embodiment.

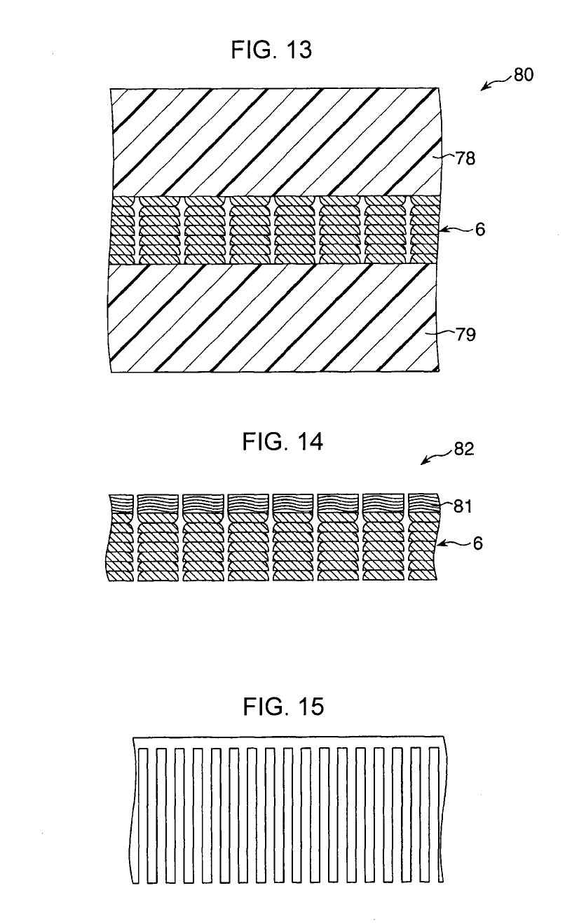

FIG. 13 is a view showing a step of a method for producing a filtration filter according to a ninth embodiment of the present invention.

In FIG. 13, first, filtration filter 6 is formed by the method for producing a filtration filter shown in FIGS. 1A˜1F, filtration filter 6 is sandwiched by two porous ceramic members (78, 79), and filtration filter 6 and two ceramic members (78, 79) are bonded together. Accordingly, complex filtration filter 80 is formed as a reverse osmosis membrane, completing the present process.

According to the method for producing a filtration filter of the present embodiment, since two ceramic members (78, 79) are bonded to filtration filter 6 where flow channels 7 with a minimum diameter of 1 nm˜100 nm are formed, the strength of resulting complex filtration filter 80 is enhanced. Also, since ceramic filters made of fine permeating holes are used as porous ceramic members (78, 79) in addition to filtration filter 6, filtration is conducted at least twice in complex filtration filter 80. Thus, contaminants, salt content, vibrio cholerae, typhoid bacillus, viruses and the like are surely removed.

In the method for producing a filtration filter of the present embodiment, filtration filter 6 is sandwiched by two ceramic members (78, 79). However, any one of the filtration filters obtained as shown in FIGS. 2A through 12B may be sandwiched by two ceramic members (78, 79).

Filtration filter 6 is sandwiched by two ceramic members (78, 79) in the present embodiment. However, it is an option for filtration filter 6 to be bonded to one ceramic member to form complex filtration filter 80.

FIG. 14 is a view showing a step of a method for producing a filtration filter according to a 10th embodiment of the present invention.

In FIG. 14, first, filtration filter 6 is formed by the method for producing a filtration filter shown in FIG. 1A˜1F. Then, using polymeric film of methyl acetate, reverse osmosis membrane 81 is formed on a surface of filtration filter 6. Accordingly, complex filtration filter 82 is formed, completing the present process.

According to the method for producing a filtration filter of the present embodiment, since filtration filter 6 having flow channels 7 with a minimum diameter of 1 nm˜100 nm is bonded to reverse osmosis membrane 81 made of polymeric film, filtration is conducted twice when sewage or seawater flows through filtration filter 6 and reverse osmosis membrane 81. Thus, contaminants, salt content or even viruses are surely removed. Also, since it is known that reverse osmosis membranes made of polymeric film are usually characterized by blocking ions by repelling or absorbing ions in water, filtration filter 6 can be used as ion blocking properties of reverse osmosis membrane 81, thus surely removing sodium ions and chloride ions in seawater.

In the method for producing a filtration filter of the present embodiment, filtration filter 6 is bonded to reverse osmosis membrane 81. However, any one of the filtration filters obtained as shown in FIGS. 2A through 12B may be bonded to reverse osmosis membrane 81.

In a method for producing filtration filters according to each embodiment, slits or circular holes are formed in each filtration filter. However, flow channels may be formed in a filtration filter through etching by processing a substrate to have a pectinate shape in a planar view. In such a case, first, multiple grooves with a width of 1 nm˜5 nm are formed in a substrate, where the periphery of one end of the substrate is open in a planar view as shown in FIG. 15, then one end of each groove is covered by a plate member or part of a frame covering the substrate to form flow channels. In doing so, cross sections of flow channels are surely enlarged so that the amount of sewage or seawater flowing through the filter is increased, enhancing the purification efficiency of producing clean water or freshwater by the filtration filter.

The purification efficiency of producing clean water or freshwater by a filtration filter in each embodiment described above decreases after being used for providing purified clean water or freshwater due to clogs caused by trapped contaminants or salt content. Thus, filtration filters are restored by conducting etching or ashing again so that trapped contaminants or salt content are removed. Since filtration filters of each embodiment are made of relatively rigid material such as silicon, they do not sustain damage or deterioration even with another etching or ashing. Namely, filtration filters of each embodiment described above are reusable. Also, if the diameter of flow channels 7 or the like is enlarged due to another etching or ashing while restoring a filtration filter, the enlarged diameter of flow channels 7 or the like will be roughly a few dozen nanometers when the initial diameter of flow channels 7 is 1 nm˜5 nm, for example. Thus, the restored filtration filter may be used for filtering sewage containing filtration targets with a size of a few hundred nanometers or greater, or it may be used for dialysis treatments. Accordingly, waste that contains contaminants or the like can be prevented by methods for producing filtration filters according to the above-described embodiments. Also, by applying water pressure from a direction opposite the filtration direction of sewage or seawater, trapped contaminants or the like may be removed. In such a case as well, since filtration filters are made of rigid material, filtration filters are tolerant to relatively high pressures, allowing efficient removal of contaminants or the like.

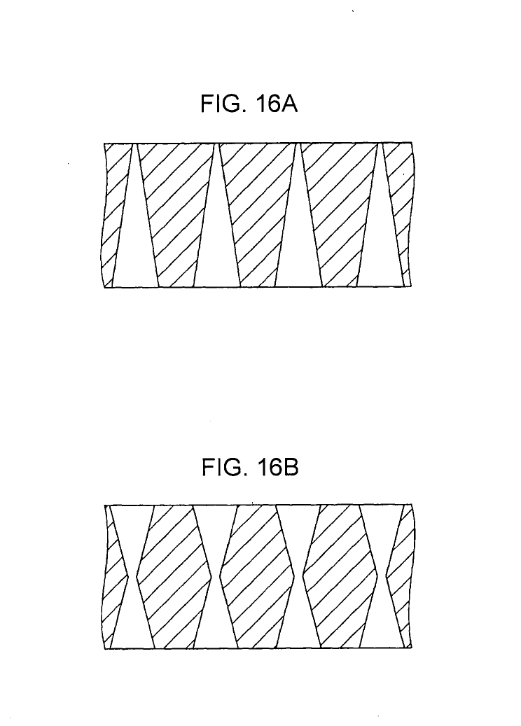

In addition, when penetrating holes are formed in filtration filters of each embodiment, the opening at one end of a penetrating hole is set at a predetermined size effective for filtration and the diameter of the penetrating hole is set to increase from that end toward the other end as shown in FIG. 16A. Alternatively, as shown in FIG. 16B, the middle portion of a penetrating hole is set to be the same predetermined size as above and the diameter of the penetrating hole is set to increase from the middle point toward both of its ends. In doing so, portions of penetrating holes that require cleansing are reduced, making it easier to cleanse the penetrating holes of filtration filters.

Also, as described above, since filtration filters of each embodiment contain relatively rigid substrates such as silicon, sterilizing or antimicrobial metals such as silver may be coated through PVD or CVD, allowing filtration filters to produce purer clean water or freshwater. Here, filtration filters may also be coated with titania, and ultraviolet rays are irradiated during the purification process of producing clean water or freshwater so that a strong sterilization effect through photocatalysis is achieved. Thus, clean water or freshwater is surely sterilized.

Moreover, it is an option for substrates contained in filtration filters of each embodiment to be formed using conductive material or semiconductive material. Accordingly, electric power is provided to filtration filters, and clean water or freshwater is sterilized by electromagnetic waves generated by the electric power.

Electronic circuits with sensor functions may be built beforehand into substrates in filtration filters of each embodiment. For example, using electronic circuits with water quality sensors built into filtration filters, the degree of purification of clean water or freshwater can be monitored real time, thus preventing low-quality clean water or freshwater.

Also, when electronic circuits with flow sensors are built into filtration filters, the amount of purified clean water or freshwater is monitored, and the timing for replacing or restoring filtration filters can be determined properly. In addition, when electronic circuits with vibration sensors are built into filtration filters, vibrations in the substrates of filtration filters are directly monitored, and the timing for replacing filtration filters can be determined properly. When forming built-in electronic circuits with sensor functions, electronic circuits are directly formed on substrates if they are made of silicon. Forming filtration filters and forming electronic circuits are achieved in the same procedures, thus simplifying the formation of electronic circuits. Therefore, substrates are preferred to be made of silicon.

Since reverse osmosis membranes are mainly formed with polymeric membranes, their strength is low. Thus, when a load is applied to sewage or seawater by increasing pressure (primary pressure) for improving purification efficiency, problems such as damaged membranes may arise.

Reverse osmosis membranes of recent development are made of porous ceramics, which will not be decayed by bacteria nor be dissolved in lubricating oil and which are highly rigid (see Japanese Patent Publication No. 2007-526819, for example). The entire contents of this publication are incorporated herein by reference.

A method for producing a filtration filter according to embodiments of the present invention can simplify the process for providing clean water or freshwater.

According to a first embodiment of the present invention, a method for producing a filtration filter includes as follows: using masking film formed on a surface of a rigid substrate and having multiple openings with a uniform size to expose portions of the surface, the portions of the substrate corresponding to the openings are etched so that multiple holes or grooves are formed in the substrate.

In the first embodiment of the present invention, the etching is preferred to be plasma dry etching.

In the first embodiment of the present invention, the diameter of the holes or the width of the grooves is preferred to be adjusted to be 1 nm˜100 nm by depositing a predetermined substance on the inner surfaces of the holes or grooves.

In the first embodiment of the present invention, the diameter of the holes or the width of the grooves is preferred to be adjusted to be 1 nm˜5 nm.

In the first embodiment of the present invention, the predetermined substance is preferred to be deposited by CVD.

In the first embodiment of the present invention, the predetermined substance is preferred to be deposited by ALD.

In the first embodiment of the present invention, it is preferred that an organic film with a thickness of 1 nm˜100 nm be formed on the inner surfaces of the holes or the grooves, and that the organic film be removed after the organic film in the holes or the grooves is covered by another material.

In the first embodiment of the present invention, the thickness of the organic film is preferred to be 1 nm˜5 nm.

In the first embodiment of the present invention, it is preferred that the diameter of the holes or the width of the grooves be 10 nm˜100 nm, and that the diameter of the holes or the width of the grooves be adjusted to be 1 nm˜5 nm by compressing the substrate in a thickness direction so that the holes or the grooves are deformed, causing the inner walls of the holes or the grooves to protrude.

In the first embodiment of the present invention, it is preferred that the diameter of the holes or the width of the grooves be 10 nm˜1000 nm, and that the diameter of the holes or the width of the grooves be adjusted to be 1 nm˜100 nm by compressing the substrate in a thickness direction so that the holes or the grooves are deformed, causing the inner walls of the holes or the grooves to protrude.

In the first embodiment of the present invention, after multiple holes or grooves are formed in the substrate, the lower surface of the substrate is preferred to be polished so that the holes or the grooves penetrate through the substrate.

In the first embodiment of the present invention, multiple substrates having holes or grooves formed as above are preferred to be laminated.

In the first embodiment of the present invention, it is preferred that an oxide film be formed on at least either the upper or lower surface of the substrate, and that the oxide film of each substrate be thermally bonded to each other when laminating multiple substrates.

In the first embodiment of the present invention, multiple holes or grooves formed as above penetrate through the substrate, and when multiple substrates are laminated, it is preferred that the holes or grooves of each substrate are aligned in a planar view to form penetrating portions that go through all the multiple substrates, and that the width of such penetrating portions be adjusted to be 1 nm˜100 nm in a planar view.

In the first embodiment of the present invention, the width of the penetrating portions is preferred to be 1 nm˜5 nm.

In the first embodiment of the present invention, the rigid substrate is preferred to be made of silicon, a metal or a metal oxide.

In the first embodiment of the present invention, the substrate with multiple holes or grooves is preferred to be bonded to another substrate made of ceramic.

In the first embodiment of the present invention, a reverse osmosis membrane made of polymeric film is preferred to be bonded to the substrate having multiple holes or grooves.

In the first embodiment of the present invention, an electrical circuit with a sensor function is preferred to be built into the substrate having multiple holes or grooves.

A method for producing a filtration filter according to a second embodiment of the present invention includes laminating multiple rigid substrates by means of organic material to have a predetermined distance from each other, and removing the organic material.

In the second embodiment of the present invention, it is preferred that holes or grooves that penetrate through each substrate be formed, and that multiple substrates be laminated in such a way that the holes or grooves of each substrate do not align in a planar view.

In the second embodiment of the present invention, the organic material is preferred to contain distance retainer with a size of 1 nm˜100 nm.

In the second embodiment of the present invention, the distance retainer is preferred to have a size of 1 nm˜5 nm.

In the second embodiment of the present invention, it is preferred that multiple substrates be laminated, penetrating holes be formed to penetrate through the multiple substrates all at once, and pillars be formed by inserting rigid members into the penetrating holes.

In the second embodiment of the present invention, multiple laminated substrates are preferred to be bonded to another substrate made of ceramic.

In the second embodiment of the present invention, a reverse osmosis membrane made of polymeric film is preferred to be bonded to multiple laminated substrates.

In the second embodiment of the present invention, an electrical circuit with a sensor function is preferred to be built into at least one of the substrates.

According to an embodiment of the present invention, using etching technology capable of achieving highly accurate processing, especially using plasma dry etching, the size and shape of opening portions of masking film are adjusted so that the diameter of multiple holes or the width and shape of grooves formed in a substrate can be directly controlled. Accordingly, when holes or grooves are formed to have a required size of diameter or width, irregularities are prevented from occurring in the diameter of holes or the width of grooves to be formed. As a result, filtration targets such as viruses with a size of a few dozen nanometers, vibrio cholerae with a size of a few hundred nanometers and contaminants are prevented from passing through the substrate. When a filtration filter containing such a substrate is used to provide clean water or freshwater, a combined use of a distillation method or the like is not required, thus simplifying the purification process for obtaining clean water or freshwater.

Also, according to another embodiment of the present invention, after multiple rigid substrates are laminated by means of organic material to set the distance between substrates at a predetermined value, the organic material is removed. Thus, the width of slits formed between adjacent substrates is directly controlled. Accordingly, when slits with a width of a few nanometers or a few dozen to one hundred nanometers are formed, irregularities are prevented from occurring in the width of slits to be formed. As a result, depending on the width of the formed slits, viruses with a size of a few dozen nanometers, vibrio cholerae with a size of a few hundred nanometers and contaminants are prevented from passing through the slits. Accordingly, a combined use of a distillation method or the like is not required when a filtration filter made of the slits is used for purification to obtain clean water or freshwater, thus simplifying the purification process for obtaining clean water or freshwater.

Furthermore, according to another embodiment of the present invention, since a rigid substrate is used for a filtration filter, primary pressure applied to sewage or seawater can be increased. Thus, the purification efficiency of producing clean water or freshwater improves.

In addition, since the shape of holes or slits is accurately controlled, maintenance efficiency improves. By setting the shape of holes or slits to be suitable for the local situation, the purification efficiency of producing clean water or freshwater is enhanced.

Obviously, numerous modifications and variations of the present invention are possible in light of the above teachings. It is therefore to be understood that within the scope of the appended claims, the invention may be practiced otherwise than as specifically described herein.

1-20. (canceled)

21. A method for producing a filtration filter, comprising:
forming on a surface of a substrate a masking film having a plurality of openings with a uniform size such that the plurality of openings of the masking film exposes a plurality of portions of the surface of the substrate;
etching the portions of the substrate exposed by the openings of the masking film such that a plurality of holes or grooves is formed in the substrate; and
depositing a substance on inner surfaces of the holes or grooves such that a diameter of the holes or a width of the grooves is adjusted to a size in a range of from 1 nm to 100 nm,
wherein the etching of the portions of the substrate comprises plasma dry etching of the portions of the substrate.

22. The method for producing a filtration filter according to claim 21, further comprising compressing the substrate in a thickness direction of the substrate such that inner walls of the holes or the grooves protrude in deformation and the diameter of the holes or the width of the grooves is adjusted to a size in a range of from 1 nm to 100 nm.

23. The method for producing a filtration filter according to claim 21, further comprising compressing the substrate in a thickness direction of the substrate such that inner walls of the holes or the grooves protrude in deformation and the diameter of the holes or the width of the grooves is adjusted to a size in a range of from 1 nm to 5 nm, wherein the depositing of the substance adjusts the diameter of the holes or the width of the grooves to a size in a range of from 10 nm to 100 nm.

24. The method for producing a filtration filter according to claim 21, further comprising:
forming the substrate having the holes or the grooves in a plurality; and
laminating the plurality of substrates.

25. The method for producing a filtration filter according to claim 24, wherein the laminating of the substrates includes forming an oxide film on at least one of an upper surface and a lower surface of each of the substrates and thermally bonding the oxide film of each of the substrates such that the plurality of substrates is laminated through the oxide film.

26. The method for producing a filtration filter according to claim 21, further comprising polishing a surface of the substrate on an opposite side with respect to the surface on which the holes or the grooves are formed such that the holes or the grooves penetrate through the substrate.

27. The method for producing a filtration filter according to claim 21, further comprising:
forming an organic film having a thickness in a range of from 1 nm to 100 nm on the inner surfaces of the holes or the grooves;
covering the organic film with a material; and
removing the organic film between the material and the inner surfaces of the holes or the grooves.

28. The method for producing a filtration filter according to claim 27, wherein the thickness of the organic film is in a range of from 1 nm to 5 nm.

29. The method for producing a filtration filter according to claim 21, wherein the substance is deposited on the inner surfaces of the holes or the grooves by CVD.

30. The method for producing a filtration filter according to claim 21, wherein the substance is deposited on the inner surfaces of the holes or the grooves by ALD.

31. The method for producing a filtration filter according to claim 21, further comprising:
forming the substrate having the holes or the grooves in a plurality; and
laminating the plurality of substrates such that the holes or grooves of each of the substrate are aligned and form a plurality of penetrating portions penetrating through the substrates,
wherein the laminating of the substrates includes adjusting the width of each of the penetrating portions to be in a range of from 1 nm to 100 nm.

32. The method for producing a filtration filter according to claim 31, wherein the adjusting of the width of each of the penetrating portions comprises setting the width of each of the penetrating portions in a range of from 1 nm to 5 nm.

33. The method for producing a filtration filter according to claim 21, wherein the substrate is made of silicon, a metal or a metal oxide.

34. The method for producing a filtration filter according to claim 21, further comprising bonding the substrate having the holes or the grooves to a ceramic substrate.

35. The method for producing a filtration filter according to claim 21, further comprising bonding a reverse osmosis membrane comprising a polymeric film to the substrate having the holes or the grooves.

36. The method for producing a filtration filter according to claim 21, further comprising building an electrical circuit having a sensor function into the substrate having the holes or the grooves.

37. A method for producing a filtration filter, comprising:
laminating a plurality of substrates through an organic material such that the organic material is interposed between the substrates and forms a space between the substrates; and
removing the organic material from the substrates such that the substrates are positioned apart by the space between the substrates,
wherein the organic material has a distance retainer having a size in a range of from 1 nm to 100 nm.

38. The method for producing a filtration filter according to claim 37, further comprising forming a plurality of holes or a plurality of grooves penetrating through each of the substrates, wherein the laminating of the substrates comprises laminating the substrates such that the holes or the grooves of each of the substrates do not align.

39. The method for producing a filtration filter according to claim 37, wherein the distance retainer has a size in a range of from 1 nm to 5 nm.

40. The method for producing a filtration filter according to claim 37, further comprising:
forming a plurality of penetrating holes penetrating through the plurality of substrates; and
inserting a plurality of rigid members into the plurality of penetrating holes, respectively, such that a plurality of pillars is formed in the plurality of penetrating holes, respectively.

41. The method for producing a filtration filter according to claim 37, further comprising bonding the plurality of substrates laminated to each other to a ceramic substrate.

42. The method for producing a filtration filter according to claim 37, further comprising bonding a reverse osmosis membrane comprising a polymeric film to the plurality of substrates laminated to each other.

43. The method for producing a filtration filter according to claim 37, further comprising building an electrical circuit having a sensor function into at least one of the substrates.
